(19) United States
(12) Patent Application Publication
(10) Pub. No.: US 2026/0239150 A1
(43) Pub. Date: Aug. 13, 2026

(54) CONDITIONAL PATH SWITHCHING UTILIZING A NEXT GENERATION NODE B

(71) Applicant: InterDigital Patent Holdings, Inc., Wilmington, DE (US)

(72) Inventors: Oumer Teyeb, Montreal (CA); Martino Freda, Laval (CA); Tuong Hoang, Montreal (CA); Ananth Kini, Conshohocken, PA (US)

(73) Assignee: InterDigital Patent Holdings, Inc., Wilmington, DE (US)

(21) Appl. No.: 19/149,666

(22) PCT Filed: Feb. 1, 2024
(86) PCT No.: PCT/US2024/013932

§ 371 Date: Jul. 21, 2025

Related U.S. Application Data
(60) Provisional application No. 63/442,793, filed on Feb. 2, 2023.

(51) Int. Cl. H04W 36/36; H04W 36/00; H04W 76/20; H04W 92/18

(52) U.S. Cl. CPC H04W 36/362; H04W 36/0058; H04W 76/20; H04W 92/18

(57) ABSTRACT

Methods, apparatuses, and computer-readable storage media for implementing condition mobility may facilitate conditional path switching. In various embodiments, handover of a WTRU from a current cell to a target cell may involve a relay WTRU, wherein the handover may occur upon specific conditions being met. For example, a remote WTRU may receive conditional path switching configuration information associated with a target relay WTRU. The information may comprise a triggering condition and sidelink (SL) reconfiguration information associated with each of a plurality of candidate relay WTRUs. Upon a determination that the triggering condition has been satisfied, the remote WTRU may apply the conditional path switching configuration information associated with the target relay WTRU.

### CROSS-REFERENCE TO RELATED APPLICATIONS

This application claims the benefit of U.S. Provisional Patent Application Number 63/442,793, filed Feb. 2, 2023, the entirety of which is incorporated by reference herein.

### BACKGROUND

A typical handover of a wireless transmit/receive unit (WTRU), also referred to as user equipment (UE), from one cell to another cell may be triggered when the radio signal quality is better in a neighboring cell than the current cell. This may be accomplished, for example, by the WTRU sending a report to the current cell, regarding radio signal quality. Upon receipt of the report, the current cell may send a handover command to the WTRU. In another example, the WTRU many monitor radio signals and when certain conditions are met, makes the decision to handover on its own. In another example, a first WTRU may configure a second WTRU to measure the signal quality of a neighboring cell, and report the results back to the first WTRU.

### SUMMARY

Disclosed herein are methods and apparatuses for implementing condition mobility. In various embodiments, handover of a WTRU from a current cell to a target cell may involve a relay WTRU, wherein the handover may occur upon specific conditions being met. Various embodiments discussed herein address how to efficiently enable conditional path switching. In an example embodiment, selection of a target relay WTRU may be made by a target gNB (next generation Node B) after initial conditional path switching by a remote WTRU. After performing path switching via a particular relay WTRU, the remote WTRU may keep other conditional path switch configurations (e.g., for a certain configured time) and may send sidelink (SL) measurements of other candidate relay WTRUs to the target gNB (e.g., in a radio resource control (RRC) reconfiguration complete message). If the remote WTRU receives a message from the target gNB with an identity of one of the candidate relay WTRUs, it may perform the path switching to the indicated relay WTRU.

An example process in which target relay WTRU selection may be made by a target gNB after initial conditional path switching by the remote WTRU, may comprise the remote WTRU performing path switching to a target relay WTRU based on fulfillment of path-switching triggering conditions. The remote WTRU may maintain other conditional path switching configurations for a configured duration. The remote WTRU may send identity and sidelink (SL) measurements of the other candidate relay WTRUs to the network that fulfill certain conditions. Upon receiving an indication from the network to switch to one of the indicated candidate relay WTRUs, the remote WTRU may change the path to the indicated relay WTRU by applying the RRC reconfiguration associated with the indicated relay WTRU. The remote WTRU may release other conditional path switch configurations.

An apparatus configured to perform a process in which target relay WTRU selection may be made by a target gNB after initial conditional path switching by the remote WTRU, may comprise a processor and a transceiver configured to facilitate path switching to a target relay WTRU based on fulfillment of path-switching triggering conditions. The apparatus further may be configured to maintain other conditional path switching configurations for a configured duration. The apparatus further may be configured to send identity and sidelink (SL) measurements of the other candidate relay WTRUs to the network that fulfill certain conditions. The apparatus further may be configured to, upon receiving an indication from the network to switch to one of the indicated candidate relay WTRUs, change the path to the indicated relay WTRU by applying the RRC reconfiguration associated with the indicated relay WTRU. The apparatus further may be configured to release other conditional path switch configurations.

An example method for performing conditional mobility may be performed by a first WTRU. The method may comprise performing path switching to a relay WTRU, wherein the first WTRU is in a first cell and the relay WTRU is in a second cell, maintaining at least one path switching condition, monitoring a candidate relay WTRU to determine if the candidate relay WTRU meets any of the at least one path switching condition, determining that the candidate relay WTRU meets at least one path switching condition of the at least one path switching condition, upon determining that the candidate relay WTRU meets the at least one path switching condition, providing an indication of the candidate relay WTRU, responsive to providing the indication of the candidate relay WTRU, receiving an indication to switch to the candidate relay WTRU, responsive to receiving the indication to switch to the candidate relay WTRU, change a path from the relay WTRU to the candidate relay WTRU, and releasing the at least one maintained path switching condition. The example method further may comprise monitoring a plurality of candidate relay WTRUs, upon a determination that at least one of the plurality of candidate relay WTRUs meet any of the at least one path switching condition, providing an indication of the at least one candidate relay WTRU. Responsive to providing the indication of the at least one candidate relay WTRU, the example method may comprise receiving an indication to switch to a selected one of the at least one candidate relay WTRU. Responsive to receiving the indication to switch to the selected candidate relay WTRU, the example method may comprise changing a path from the relay WTRU to the selected candidate relay WTRU. At least one path switching condition may comprise a candidate relay WTRU being in the second cell. At least one path switching condition may comprise a candidate relay WTRU having a SL radio condition above a threshold. Providing the indication of the candidate relay WTRU may comprise providing an identity of the candidate relay WTRU. Providing the indication of the candidate relay WTRU may comprise providing a sidelink (SL) measurement associated with the candidate relay WTRU. The indication to switch to the candidate relay WTRU may comprise a radio resource control (RRC) reconfiguration message. Providing the indication of the candidate relay WTRU may comprise providing an indication of the candidate relay WTRU to a next generation Node B (gNB) associated with the second cell. The indication to switch to the candidate relay WTRU may be provided by a gNB associated with the second cell.

An example WTRU configured to perform conditional mobility may comprise a processor and a transceiver. The WTRU may be configured to perform path switching to a relay WTRU, wherein the WTRU is in a first cell and the relay WTRU is in a second cell, maintain at least one path switching condition, monitor a candidate relay WTRU to determine if the candidate relay WTRU meets any of the at least one path switching condition, determine that the candidate relay WTRU meets at least one path switching condition of the at least one path switching condition, upon determining that the candidate relay WTRU meets the at least one path switching condition, provide an indication of the candidate relay WTRU, responsive to providing the indication of the candidate relay WTRU, receive an indication to switch to the candidate relay WTRU, responsive to receiving the indication to switch to the candidate relay WTRU, change a path from the relay WTRU to the candidate relay WTRU, and release the at least one maintained path switching condition. The example WTRU further may be configured to monitor a plurality of candidate relay WTRUs, upon a determination that at least one of the plurality of candidate relay WTRUs meet any of the at least one path switching condition, provide an indication of the at least one candidate relay WTRU. Responsive to providing the indication of the at least one candidate relay WTRU, the WTRU may be configured to receive an indication to switch to a selected one of the at least one candidate relay WTRU. Responsive to receiving the indication to switch to the selected candidate relay WTRU, the WTRU may be configured to change a path from the relay WTRU to the selected candidate relay WTRU. At least one path switching condition may comprise a candidate relay WTRU being in the second cell. At least one path switching condition may comprise a candidate relay WTRU having a SL radio condition above a threshold. Providing the indication of the candidate relay WTRU may comprise providing an identity of the candidate relay WTRU. Providing the indication of the candidate relay WTRU may comprise providing a sidelink (SL) measurement associated with the candidate relay WTRU. The indication to switch to the candidate relay WTRU may comprise a radio resource control (RRC) reconfiguration message. Providing the indication of the candidate relay WTRU may comprise providing an indication of the candidate relay WTRU to a next generation Node B (gNB) associated with the second cell. The indication to switch to the candidate relay WTRU may be provided by a gNB associated with the second cell.

An example computer-readable storage medium may have executable instructions stored thereon that when executed by a processor, cause the processer to facilitate conditional mobility. When the executable instructions are executed, the processor may be configured to facilitate a WTRU to perform path switching to a relay WTRU, wherein the WTRU is in a first cell and the relay WTRU is in a second cell, maintain at least one path switching condition, monitor a candidate relay WTRU to determine if the candidate relay WTRU meets any of the at least one path switching condition, determine that the candidate relay WTRU meets at least one path switching condition of the at least one path switching condition, upon determining that the candidate relay WTRU meets the at least one path switching condition, provide an indication of the candidate relay WTRU, responsive to providing the indication of the candidate relay WTRU, receive an indication to switch to the candidate relay WTRU, responsive to receiving the indication to switch to the candidate relay WTRU, change a path from the relay WTRU to the candidate relay WTRU, and release the at least one maintained path switching condition. Execution of the executable instructions may further cause the processor to facilitate the WTRU monitor a plurality of candidate relay WTRUs, upon a determination that at least one of the plurality of candidate relay WTRUs meet any of the at least one path switching condition, provide an indication of the at least one candidate relay WTRU. Responsive to providing the indication of the at least one candidate relay WTRU, the WTRU may be configured to receive an indication to switch to a selected one of the at least one candidate relay WTRU. Responsive to receiving the indication to switch to the selected candidate relay WTRU, the WTRU may be configured to change a path from the relay WTRU to the selected candidate relay WTRU. At least one path switching condition may comprise a candidate relay WTRU being in the second cell. At least one path switching condition may comprise a candidate relay WTRU having a SL radio condition above a threshold. Providing the indication of the candidate relay WTRU may comprise providing an identity of the candidate relay WTRU. Providing the indication of the candidate relay WTRU may comprise providing a sidelink (SL) measurement associated with the candidate relay WTRU. The indication to switch to the candidate relay WTRU may comprise a radio resource control (RRC) reconfiguration message. Providing the indication of the candidate relay WTRU may comprise providing an indication of the candidate relay WTRU to a next generation Node B (gNB) associated with the second cell. The indication to switch to the candidate relay WTRU may be provided by a gNB associated with the second cell.

An example method for facilitating conditional mobility may be performed by a remote WTRU. The method may comprise receiving conditional path switching configuration information associated with a target cell. The conditional path switching configuration information may be received via a relay WTRU. The conditional path switching configuration information may comprise a triggering condition and sidelink (SL) reconfiguration information associated with each of a plurality of candidate relay WTRUs. The method further may comprise determining that the triggering condition has been satisfied for a target relay WTRU of the plurality of candidate relay WTRUs associated with the target cell. Additionally, the method may comprise, upon determining that the triggering condition has been satisfied, applying the conditional path switching configuration information associated with the target relay WTRU may be applied to the remote WTRU, sending a message comprising an identity of the remote WTRU via the target relay WTRU, and releasing the conditional path switching configuration information associated with each of the candidate relay WTRUs of the plurality of candidate relay WTRUs other than the target relay WTRU. Releasing the conditional path switching configuration information associated with each of the candidate relay WTRUs of the plurality of candidate relay WTRUs other than the target relay WTRU may comprise releasing a respective PC5 link with each of the candidate relay WTRUs of the plurality of candidate relay WTRUs other than the target relay WTRU. The triggering condition may comprise a radio condition. The triggering condition may comprise a measurement threshold associated with one or more relay WTRUs associated with the target cell. The triggering condition may be based on a radio quality associated with the target cell. The triggering condition may be based on a radio quality associated with the target cell and a neighbor cell to trigger a measurement report. The received conditional path switching configuration information may comprise radio resource control (RRC) information. The SL reconfiguration information may comprise an SL path switch configuration. The SL configuration information may comprise information associated with SL-related operations of the remote WTRU. The message may comprise an RRCReconfigurationComplete message.

An example remote WTRU for facilitating conditional mobility may comprise a transceiver and a processor. The processor may be configured to receive, via the transceiver, conditional path switching configuration information associated with a target cell. The conditional path switching configuration information may be received via a relay WTRU. The conditional path switching configuration information may comprise a triggering condition and sidelink (SL) reconfiguration information associated with each of a plurality of candidate relay WTRUs. The processor may be configured to determine that the triggering condition has been satisfied for a target relay WTRU of the plurality of candidate relay WTRUs associated with the target cell. The processor may be configured to, upon the determination that the triggering condition has been satisfied apply the conditional path switching configuration information associated with the target relay WTRU, send, via the transceiver, a message to a network node, wherein the message is sent via the target relay WTRU, and wherein the message comprises an identity of the remote WTRU, and release the conditional path switching configuration information associated with each of the candidate relay WTRUs of the plurality of candidate relay WTRUs other than the target relay WTRU. To release the conditional path switching configuration information associated with each of the candidate relay WTRUs of the plurality of candidate relay WTRUs other than the target relay WTRU may comprise to release a respective PC5 link with each of the candidate relay WTRUs of the plurality of candidate relay WTRUs other than the target relay WTRU. The triggering condition may comprise a radio condition. The triggering condition may comprise a measurement threshold associated with one or more relay WTRUs associated with the target cell. The triggering condition may be based on a radio quality associated with the target cell. The triggering condition may be based on a radio quality associated with the target cell and a neighbor cell to trigger a measurement report. The received conditional path switching configuration information may comprise radio resource control (RRC) information. The SL reconfiguration information may comprise an SL path switch configuration. The SL configuration information may comprise information associated with SL-related operations of the remote WTRU. The message may comprise an RRCReconfigurationComplete message.

An example computer-readable storage medium may have executable instructions stored thereon that when executed by a processor, cause the processer to facilitate conditional mobility. When the executable instructions are executed, the processor may be configured to receive conditional path switching configuration information associated with a target cell. The conditional path switching configuration information may be received via a relay WTRU. The conditional path switching configuration information may comprise a triggering condition and sidelink (SL) reconfiguration information associated with each of a plurality of candidate relay WTRUs. When the executable instructions are executed, the processor further may be configured to determine that the triggering condition has been satisfied for a target relay WTRU of the plurality of candidate relay WTRUs associated with the target cell. Additionally, when the executable instructions are executed, the processor may further be configured to, upon a determination that the triggering condition has been satisfied, apply the conditional path switching configuration information associated with the target relay WTRU, send a message comprising an identity of the remote WTRU via the target relay WTRU, and release the conditional path switching configuration information associated with each of the candidate relay WTRUs of the plurality of candidate relay WTRUs other than the target relay WTRU. To release the conditional path switching configuration information associated with each of the candidate relay WTRUs of the plurality of candidate relay WTRUs other than the target relay WTRU may comprise to release a respective PC5 link with each of the candidate relay WTRUs of the plurality of candidate relay WTRUs other than the target relay WTRU. The triggering condition may comprise a radio condition. The triggering condition may comprise a measurement threshold associated with one or more relay WTRUs associated with the target cell. The triggering condition may be based on a radio quality associated with the target cell. The triggering condition may be based on a radio quality associated with the target cell and a neighbor cell to trigger a measurement report. The received conditional path switching configuration information may comprise radio resource control (RRC) information. The SL reconfiguration information may comprise an SL path switch configuration. The SL configuration information may comprise information associated with SL-related operations of the remote WTRU. The message may comprise an RRCReconfigurationComplete message.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures and the detailed description are not to be considered limiting, and other equally effective examples are possible and likely. Like reference numerals (“ref.” or “refs.”) in the Figures indicate like elements.

FIG. 1A is an example system diagram illustrating an example communications system in which one or more disclosed embodiments may be implemented.

FIG. 1B is an example system diagram illustrating an example wireless transmit/receive unit (WTRU) that may be used within the communications system illustrated in FIG. 1A according to an embodiment.

FIG. 1C is an example system diagram illustrating an example radio access network (RAN) and an example core network (CN) that may be used within the communications system illustrated in FIG. 1A according to an embodiment.

FIG. 1D is an example system diagram illustrating a further example RAN and a further example CN that may be used within the communications system illustrated in FIG. 1A according to an embodiment.

FIG. 2 depicts an example user plane protocol stack for a layer 2 (L2 ) WTRU-to-Network relay.

FIG. 3 depicts an example control plane protocol stack for an L2 WTRU-to-Network relay.

FIG. 4 depicts an example discovery message protocol stack for an L2 WTRU-to-Network relay.

FIG. 5 depicts an example procedure for L2 user-to-network (U2N) switching to direct user-to-user (Uu) cell.

FIG. 6 depicts an example procedure for L2 U2N remote WTRU switching to indirect path via an L2 U2N relay WTRU in radio resource control connected (RRC_Connected) mode.

FIG. 7 depicts an example of direct to indirect switching utilizing inter-gNB (next generation Node B).

FIG. 8 depicts an example conditional handover configuration and execution.

FIG. 9 depicts an example conditional handover scenario.

### EXAMPLE NETWORKS FOR IMPLEMENTATION OF THE INVENTION

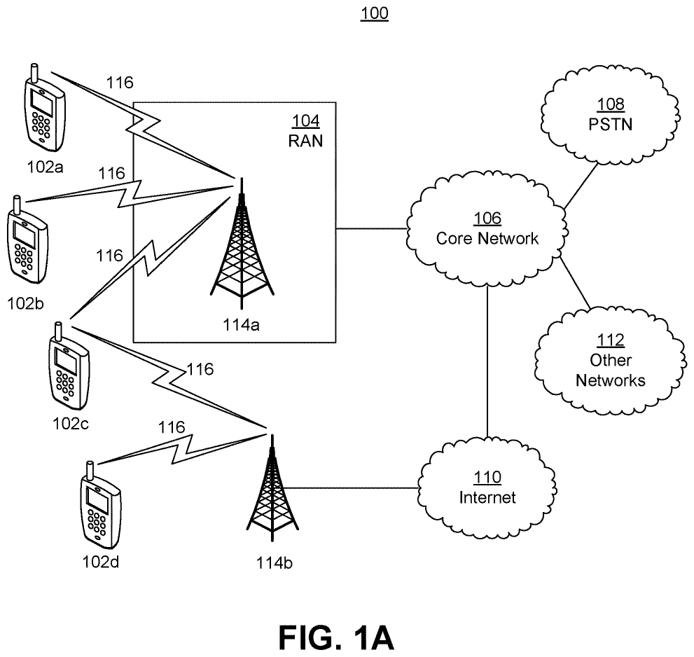

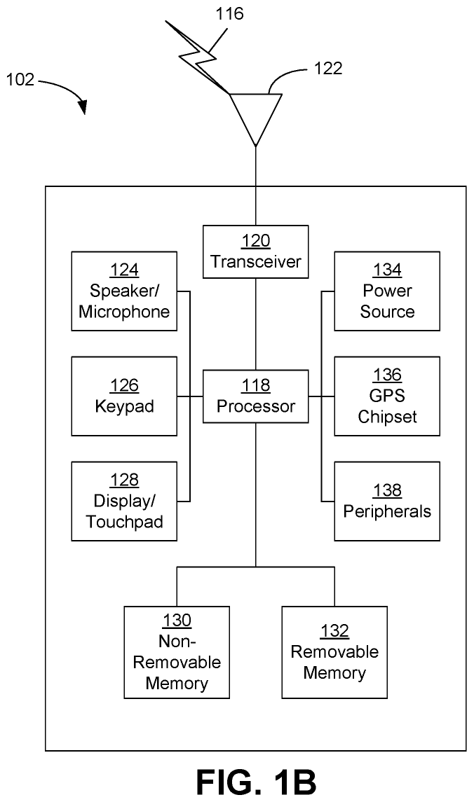

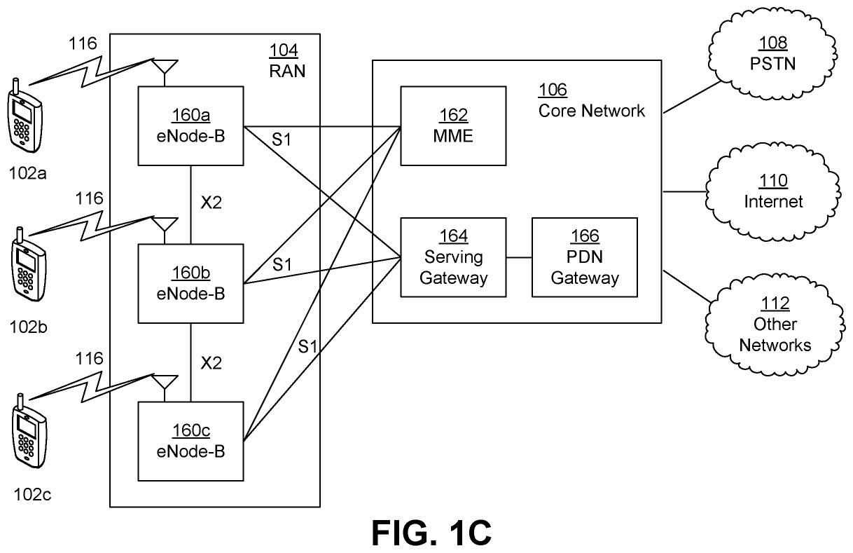

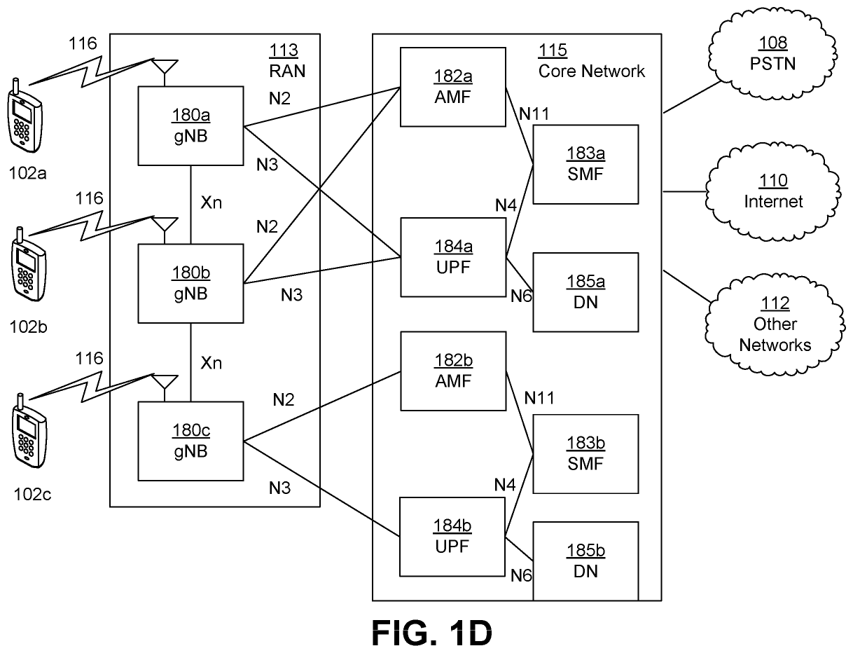

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attachment of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example, in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80 +80 configuration. For the 80 +80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80 +80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like.

Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP (third generation partnership project) access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Described herein are mechanisms for conditional handover and conditional path switching. In various example scenarios, a relay WTRU may be utilized in conjunction with a network. An example WTRU to network relay architecture is described below.

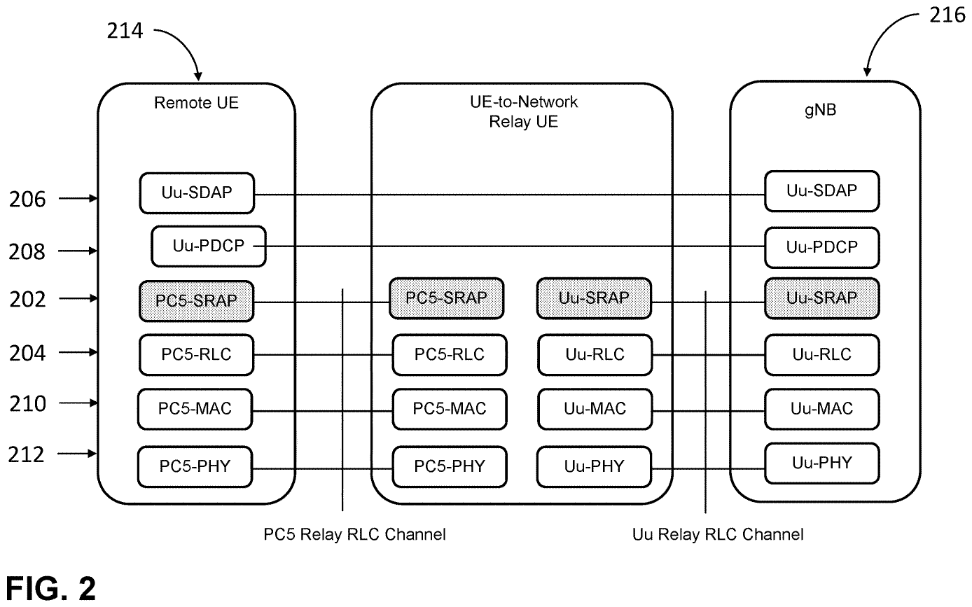

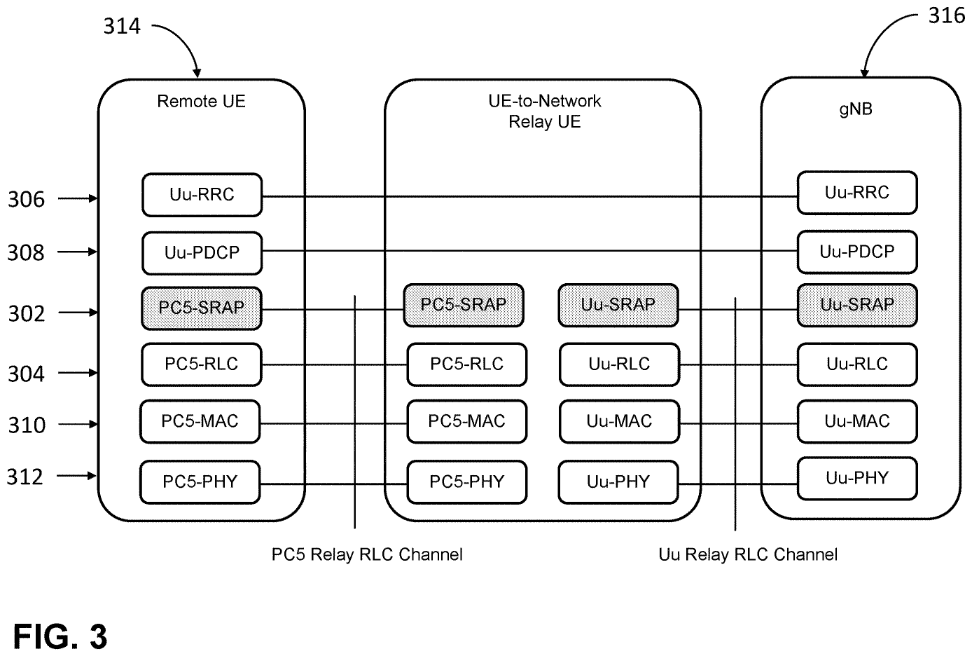

Example protocol stacks for the user plane and control plane of layer 2 (L2) UE-to-network (U2N) Relay architecture are illustrated in FIG. 2 and FIG. 3, respectively. FIG. 2 depicts an example user plane protocol stack for a layer 2 (L2) WTRU-to-Network relay. And FIG. 3 depicts an example control plane protocol stack for an L2 WTRU-to-Network relay. The SRAP (Sidelink Relay Adaptation Protocol) sublayer (202 in FIGS. 2, 302 in FIG. 3) may be placed above the radio control link (RLC) sublayer (204 in FIGS. 2, 304 in FIG. 3) for both CP and UP at both PC5 interface and user-to-user (Uu) interface. The Uu SDAP (service data adaption protocol) (206 in FIGS. 2, 306 in FIG. 3), PDCP (packet data convergence protocol) (208 in FIGS. 2, 308 in FIG. 3), and RRC (radio resource control) may be terminated between L2 U2N Remote WTRU (214 in FIGS. 2, 314 in FIG. 3) and an appropriate network node, e.g., gNB (next generation Node B) (216 in FIGS. 2, 316 in FIG. 3), while SRAP, RLC, MAC (medium access control) (210 in FIGS. 2, 310 in FIG. 3) and PHY (physical layer) (212 in FIGS. 2, 312 in FIG. 3) may be terminated in each hop (e.g., the link between L2 U2N Remote WTRU and the L2 U2N Relay WTRU and the link between L2 U2N Relay WTRU and the network node gNB).

For L2 U2N Relay, the SRAP sublayer over PC5 hop may be for the purpose of bearer mapping. The SRAP sublayer may not be present over PC5 hop for relaying the L2 U2N Remote UE's message on BCCH and PCCH. For L2 U2N Remote UE's message on SRB0, the SRAP header is not present over PC5 hop, but the SRAP header is present over Uu hop for both DL and UL.

Relay discovery may be used in WTRU to NW (network) relays for a remote WTRU to perform relay selection (when in RRC_IDLE/RRC_INACTIVE) and also for a remote WTRU to send measurements of potential relays to the network (for a remote WTRU in RRC_CONNECTED) for potential path switch decisions by the network.

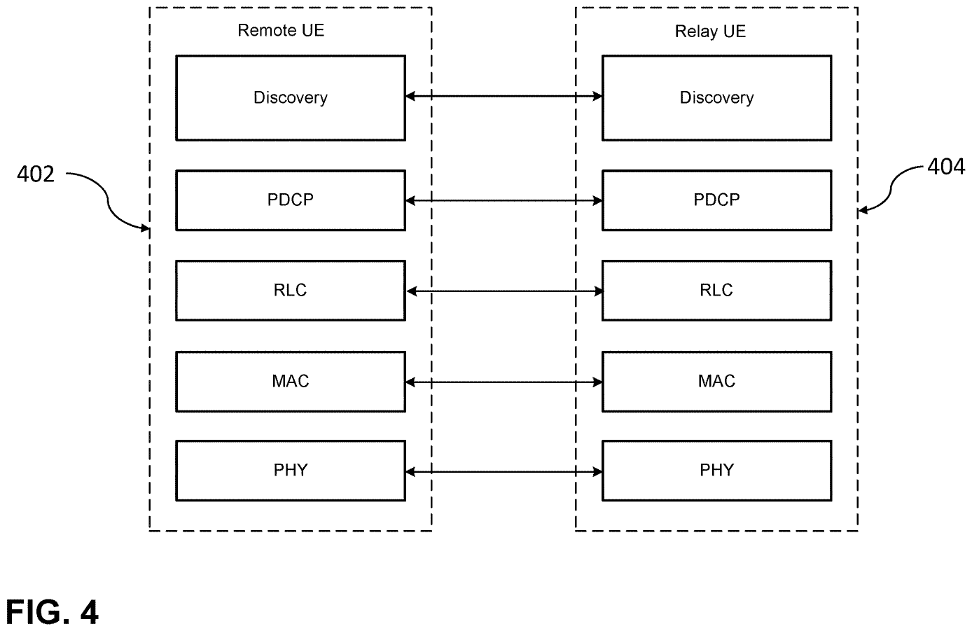

Model A and Model B discovery models may be supported for U2N Relay discovery. An example protocol stack that may be used for discovery is illustrated in FIG. 4. The U2N Remote WTRU 402 may perform Relay discovery message transmission and may monitor the sidelink for Relay discovery messages while in RRC_IDLE, RRC_INACTIVE or RRC_CONNECTED. The network may broadcast or configure via dedicated RRC signaling a Uu RSRP (reference signal received power) threshold, which may be used by the U2N Remote WTRU 402 to determine if it can transmit Relay discovery messages to U2N Relay WTRU(s) 404.

The U2N Relay WTRU 404 may perform Relay discovery message transmission and may monitor the sidelink for Relay discovery messages while in RRC_IDLE, RRC_INACTIVE or RRC_CONNECTED. The network may broadcast or configure via dedicated RRC signaling a maximum Uu RSRP threshold, a minimum Uu RSRP threshold, or both, which are used by the U2N Relay WTRU 404 to determine if it can transmit Relay discovery messages to U2N Remote WTRU(s) 402.

The network may provide the Relay discovery configuration using broadcast or dedicated signaling for Relay discovery. In addition, the U2N Remote WTRU 402 and U2N Relay WTRU 404 may use pre-configuration for Relay discovery.

Regarding mobility in WTRU to network relays, a service continuity procedure may be applicable for mobility cases of path switch from indirect to direct path, and from direct to indirect path when the L2 U2N Remote WTRU and L2 U2N Relay WTRU belong to the same network node, e.g., gNB. Other cases (e.g., indirect to indirect, as well as direct to indirect and indirect to direct for different network nodes, e.g., gNBs) may be supported.

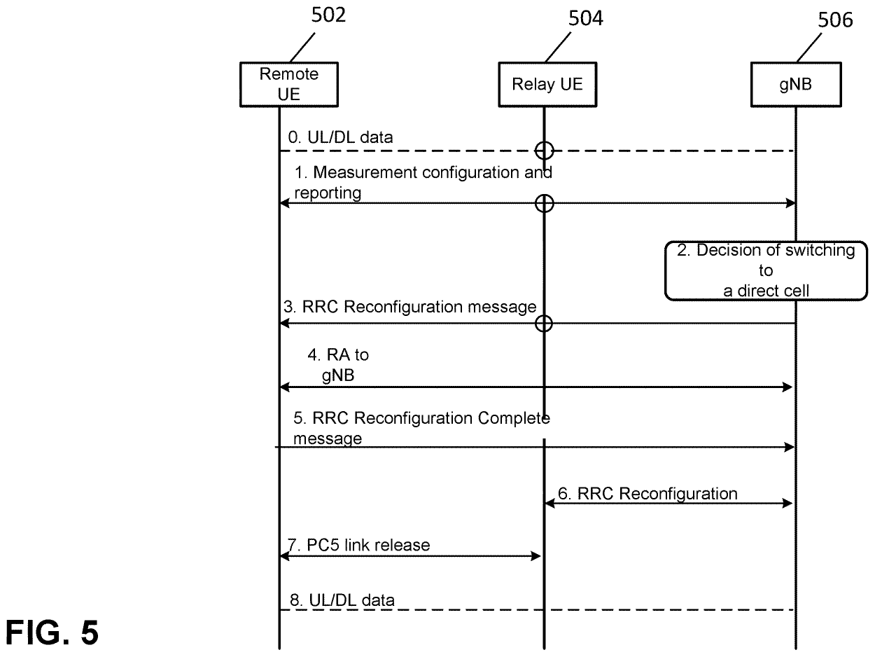

Regarding switching from indirect to direct path for service continuity of L2 U2N Relay, the following procedure may be used, in the case of an L2 U2N Remote WTRU switching to direct path as depicted in FIG. 5. FIG. 5 depicts an example procedure of an L2 U2N Remote WTRU 502 switching to a direct Uu cell. At step 1, Uu measurement configuration and measurement report signaling procedures may be performed to evaluate both relay link measurement and Uu link measurement. The measurement results from L2 U2N Remote WTRU 502 may be reported when configured measurement reporting criteria are met. The sidelink relay measurement report may include an L2 U2N Relay WTRU's 504 source L2 ID (identifier), serving cell ID (e.g., NCGI (NR cell global identity)/NCI (NR cell identity), sidelink measurement quantity result, or any appropriate combination thereof. The sidelink measurement quantity may include a SL-RSRP of the serving L2 U2N Relay WTRU, and if SL-RSRP is not available, SD-RSRP (sidelink discovery reference signal received power) may be used.

At step 2, the network node, e.g., gNB 506, may decide to switch the L2 U2N Remote WTRU onto a direct Uu path. At step 3, the network node, e.g., gNB 506, may send the RRCReconfiguration message to the L2 U2N Remote WTRU. The L2 U2N Remote WTRU 502 may stop UP and CP transmissions via the L2 U2N Relay WTRU 504 after reception of the RRCReconfiguration message with the path switch configuration. At step 4, the L2 U2N Remote WTRU 502 may synchronize with the network node, e.g., gNB 506, and may perform Random Access. At step 5, the WTRU 502 (e.g., L2 U2N Remote WTRU in previous steps) may send the RRCReconfiguration Complete message to the gNB 506 via the direct path, using the configuration provided in the RRCReconfiguration message. From this step, the WTRU 502 (e.g., L2 U2N Remote WTRU in previous steps) may use the RRC connection via the direct path to the network node, e.g., gNB 506.

At step 6, the network node, e.g., gNB 506, may send the RRCReconfiguration message to the L2 U2N Relay WTRU 504 to reconfigure the connection between the L2 U2N Relay WTRU 504 and the network node, e.g., gNB 506. The RRCReconfiguration message to the L2 U2N Relay WTRU 504 may be sent any time after step 3 based on network node, e.g., gNB 506, implementation (e.g., to release Uu and PC5 Relay RLC channel configuration for relaying, and bearer mapping configuration related to the L2 U2N Remote UE).

At step 7, either L2 U2N Relay WTRU 504 or L2 U2N Remote WTRU's 502 AS (access stratum) layer may release the PC5-RC connection and may indicate upper layers to release PC5 unicast link after receiving the RRCReconfiguration message from the network node, e.g., gNB 506. The timing to execute link release may be determined by the WTRU implementation. At step 8, the data path may be switched from indirect path to direct path between the WTRU 502 (e.g., previous L2 U2N Remote WTRU) and the network node, e.g., gNB 506. The PDCP re-establishment or PDCP (packet data convergence protocol) data recovery in uplink may be performed by the WTRU 502 (e.g., previous L2 U2N Remote WTRU) for lossless delivery during path switch if network node, e.g., gNB 506, configures it. Step 8 may be executed any time after step 4. Step 8 may be independent of step 6 and step 7.

When switching from direct to indirect path, the network node, e.g., gNB 506, may select an L2 U2N Relay WTRU in any RRC state such as, RRC_IDLE, RRC_INACTIVE, or RRC_CONNECTED, as a target L2 U2N Relay WTRU for direct to indirect path switch.

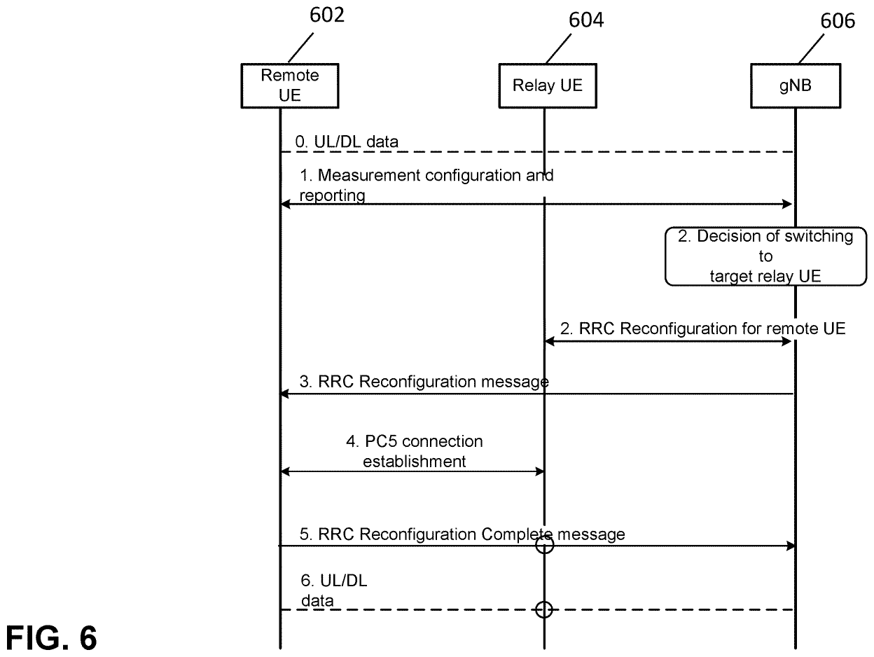

For service continuity of L2 U2N Remote WTRU, the following procedure, as depicted inf FIG. 6, may be used, in case of the L2 U2N Remote WTRU switching to indirect path via a L2 U2N Relay WTRU in RRC_CONNECTED. At step 1, the L2 U2N Remote WTRU 602 may report one or multiple candidate L2 U2N Relay WTRU(s) 604 and Uu measurements, after it measures/discovers the candidate L2 U2N Relay WTRU(s) 604. The L2 U2N Remote WTRU 602 may filter the appropriate L2 U2N Relay WTRU(s) 604 according to relay selection criteria before reporting. The L2 U2N Remote WTRU 602 may report the L2 U2N Relay WTRU 604 candidate(s) that fulfil the higher layer criteria. The reporting may include an L2 U2N Relay WTRU 604 ID, an L2 U2N Relay WTRU's 604 serving cell ID, a sidelink measurement quantity information, or any appropriate combination thereof. SD-RSRP may be used as a sidelink measurement quantity.

At step 2, the network node, e.g., gNB 606, may decide to switch the L2 U2N Remote WTRU 602 to a target L2 U2N Relay WTRU 604. The network node, e.g., gNB 606, may then send an RRCReconfiguration message to the target L2 U2N Relay WTRU 604, which may include the L2 U2N Remote WTRU's 602 local ID and L2 ID, Uu and PC5 Relay RLC (radio link control) channel configuration for relaying, bearer mapping configuration, or any appropriate combination thereof. At step 3, the network node, e.g., gNB 606, may send the RRCReconfiguration message to the L2 U2N Remote WTRU. The RRCReconfiguration message may include the L2 U2N Relay WTRU ID, Remote WTRU's 602 local ID, PC5 Relay RLC channel configuration for relay traffic and the associated end-to-end radio bearer(s), or any appropriate combination thereof. The L2 U2N Remote WTRU may stop UP and CP transmission over the direct path after reception of the RRCReconfiguration message from the network node, e.g., gNB 606.

At step 4, the L2 U2N Remote WTRU 602 may establish a PC5 RRC connection with target L2 U2N Relay WTRU 604. At step 5, the L2 U2N Remote WTRU 602 may complete the path switch procedure by sending the RRCReconfiguration Complete message to the network node, e.g., gNB 606, via the L2 U2N Relay WTRU 604. At step 6, the data path may be switched from direct path to indirect path between the L2 U2N Remote WTRU 602 and the network node, e.g., gNB 606.

In case the selected L2 U2N Relay WTRU 604 for direct to indirect path switch is in RRC_IDLE or RRC_INACTIVE, after receiving the path switch command, the L2 U2N Remote WTRU 602 may establish a PC5 link with the L2 U2N Relay WTRU 604 and may send the RRCReconfiguration Complete message via the L2 U2N Relay WTRU 604, which may trigger the L2 U2N Relay WTRU 604 to enter RRC_CONNECTED state. The procedure for L2 U2N Remote WTRU 602 switching to indirect path also may be applied for the case that the selected L2 U2N Relay WTRU 604 for direct to indirect path switch is in RRC_IDLE or RRC_INACTIVE with the exception that the RRCReconfiguration message may be sent from the network node, e.g., gNB 606, to the L2 U2N Relay WTRU 604 after the L2 U2N Relay WTRU 604 enters RRC_CONNECTED state, which happens between step 4 and step 5.

U2N relaying as described herein, may be applicable to indirect to indirect switching for the intra-network node case, such as intra-gNB case, and switching options for the inter-network node case, such as inter-gNB case (direct to indirect, indirect to direct, indirect to indirect). In the following description, the terms “network node,” “gNB X” and “gNB Y” may be used interchangeably. Mechanisms to enhance service continuity for single-hop Layer-2 WTRU-to-Network relay may be applicable to the following scenarios [RAN2, RAN3]: inter-gNB indirect-to-direct path switching (e.g., “remote WTRU <->relay WTRU A <->gNB X” to “remote WTRU <->gNB Y”), inter-gNB direct-to-indirect path switching (e.g., “remote WTRU <->gNB X” to “remote WTRU <->relay WTRU A <->gNB Y”), intra-gNB indirect-to-indirect path switching (e.g., “remote WTRU <->relay WTRU A <->gNB X” to “remote WTRU <->relay WTRU B <->gNB X”), and inter-gNB indirect-to-indirect path switching (e.g., “remote WTRU <->relay WTRU A <->gNB X” to “remote WTRU <->relay WTRU B <->gNB Y”).

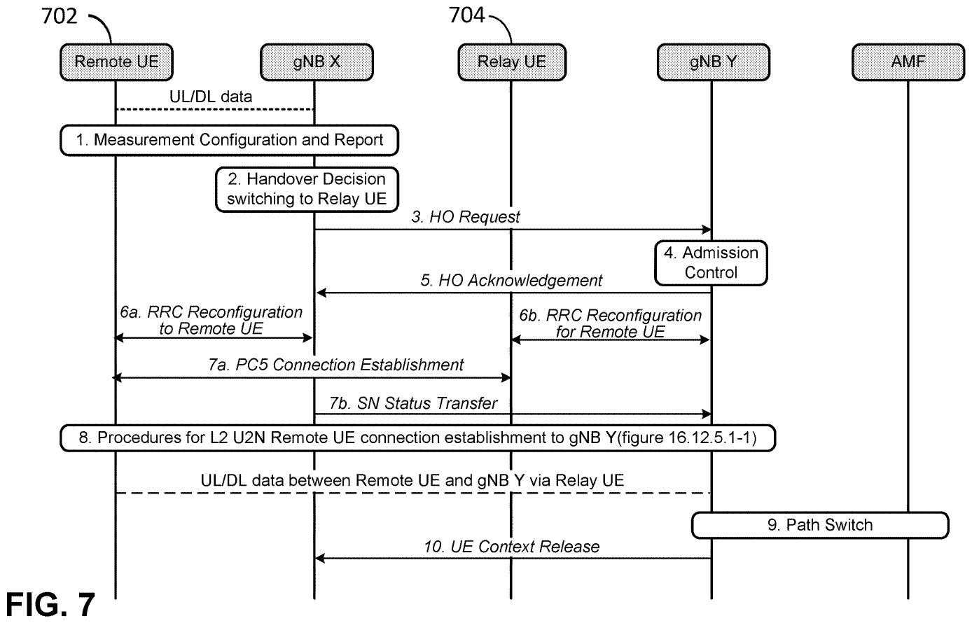

An example extension of the direct to indirect switching for the inter-gNB case is depicted in FIG. 7. FIG. 7 depicts an example of direct to indirect switching utilizing inter-gNB. As can be seen in FIG. 7, a difference in the intra-gNB case is that the reconfiguration of the target relay WTRU 704 for the sake of the remote WTRU 702 may be done directly from the target gNB.

In various example embodiments regarding direct/indirect to indirect path switching, a source or target network node/cell may decide the target relay WTRU. Factors to be considered may include the remote WTRU not being aware of the backhaul Uu link qualities of the candidate relay WTRUs when it is performing measurements and as such the measurement configuration from the source to the remote WTRU that triggers the HO (handover) decision by the source gNB may be based on the link from the remote WTRU to the source (Uu or SL) and the target relay. That is, a HO may be triggered towards a target relay WTRU that has excellent conditions to the remote WTRU, but which may have a bad backhaul Uu link to the target network node/cell.

Two example options for performing inter-gNB path switching from direct/indirect to indirect may include (1) a source gNB may select the target relay WTRU, and (2) a source gNB may send a list of candidate relay WTRUs to the target gNB and target gNB may chose the final target relay among these (e.g., considering the backhaul Uu link quality towards the indicated relay WTRUs).

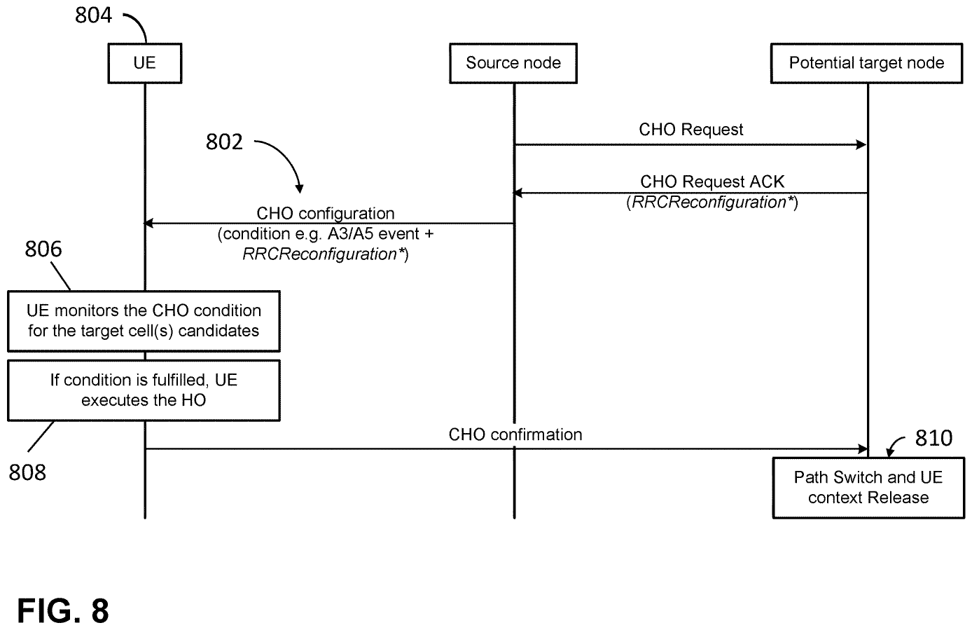

FIG. 8 depicts an example process for conditional handover (CHO) configuration and execution. CHO and conditional PSCell Addition/Change (CPA/CPC, or collectively referred to as CPAC), may reduce the likelihood of radio link failures (RLF) and handover failures (HOF). Legacy LTE/NR handover may typically be triggered by measurement reports, even though there is nothing preventing the network from sending a HO command to the WTRU even without receiving a measurement report. For example, the WTRU may be configured with an A3 event that triggers a measurement report to be sent when the radio signal level/quality (RSRP, RSRQ, etc.) of a neighbor cell becomes better than the Primary serving cell (PCell) or also the Primary Secondary serving Cell (PSCell), in the case of Dual Connectivity (DC). The WTRU may monitor the serving and neighbor cells and may send a measurement report when the conditions are fulfilled. When such a report is received, the network (current serving node/cell) may prepare a HO command (e.g., a RRC Reconfiguration message, with a reconfiguration WithSync) and may send it to the WTRU, which the WTRU may execute resulting in the WTRU connecting to the target cell.

CHO may differ from legacy handover in that multiple handover targets may be prepared (as compared to only one target in legacy case), and the WTRU may not immediately execute the CHO as in the case of the legacy handover. Instead, the WTRU may be configured with triggering conditions comprising a set of radio conditions, and the WTRU may execute the handover towards one of the targets when/if the triggering conditions are fulfilled.

The CHO command may be sent when the radio conditions towards the current serving cells are still favorable, thereby reducing the two points of failure in legacy handover, e.g., risk failing to send the measurement report (e.g., if the link quality to the current serving cell falls below acceptable levels when the measurement reports are triggered in normal handover) and the failure to receive the handover command (e.g., if the link quality to the current serving cell falls below acceptable levels after the WTRU has sent the measurement report, but before it has received the HO command).

The triggering conditions for a CHO may be based on the radio quality of the serving cells and neighbor cells to trigger measurement reports. For example, the WTRU may be configured with a CHO that has an A3 like triggering conditions and associated HO command (802). The WTRU 804 may monitor the current and serving cells (806) and when the A3 triggering conditions are fulfilled, it will, instead of sending a measurement report, executes the associated HO command (808) and switches its connection towards the target cell (810).

CHO may help prevent unnecessary re-establishments in case of a radio link failure (RLF). For example, assume a WTRU is configured with multiple CHO targets and the WTRU experiences an RLF before the triggering conditions with any of the targets get fulfilled. Legacy operation would have resulted in a RRC re-establishment procedure that would have incurred considerable interruption time for the bearers of the WTRU. However, in the case of CHO, if the WTRU, after detecting an RLF, ends up with a cell for which it has a CHO associated with (e.g., the target cell is already prepared for it), the WTRU may execute the HO command associated with this target cell directly, instead of continuing with the full re-establishment procedure.

CPC and CPA may be considered extensions of CHO, in DC scenarios. A WTRU may be configured with triggering conditions for PSCell change or addition, and when the triggering conditions are fulfilled, it may execute the associated PSCell change or PSCell add commands.

In sidelink (SL) operation, a WTRU may configure an associated peer WTRU to perform NR sidelink measurements and reports on the corresponding PC5-RRC connection in accordance with the NR sidelink measurement configuration for unicast by RRCReconfiguration Sidelink message. A WTRU may derive NR sidelink measurement results by measuring one or multiple DMRS (demodulation references signals) associated per PC5-RRC connection as configured by the peer WTRU associated. For NR sidelink measurement results the WTRU may apply layer 3 filtering before using the measured results for evaluation of reporting criteria and measurement reporting. In an example embodiment NR sidelink RSRP may be configured as trigger quantity and reporting quantity.

Regarding measurement events for NR sidelink, the following terms are used herein. Event S1 refers to a service becoming better than a threshold, and Event S2 refers to service becoming worse than a threshold. The S1 and S2 based measurement (reports) may be used by the WTRU receiving the report to adjust the power level when transmitting data. NR sidelink transmissions may have the following two modes of resource allocations. Mode 1 refers to sidelink resources being scheduled by a gNB, and Mode 2 refers to the WTRU autonomously selecting sidelink resources from a (pre-)configured sidelink resource pool(s) based on the channel sensing mechanism. For the in-coverage WTRU, WTRUs may be configured to operate in Mode 1 or Mode 2. For the out-of-coverage WTRU, Mode 2 may be adopted. To enhance QOS (quality of service) of NR sidelink transmissions, congestion control, such as Mode 2, may be utilized to prevent a transmitting WTRU from occupying too many resources in sidelink transmissions. Two metrices are described herein for this purpose. Channel Busy Ratio (CBR) refers to the portion of subchannels whose RSSI (received signal strength indictor) exceeds a preconfigured value over a certain time duration. Channel Occupation Ratio (CR) refers to, when considering a particular slot n, the CR is (X+Y)M, where X is the number of the subchannels that have been occupied by a transmitting WTRU within [n−a, n−1], Y is the number of the subchannels that have been granted within [n, n+b], and M is the total number of subchannels within [n−a, n+b].

For congestion control, an upper bound of CR denoted by CRₗᵢₘᵢₜ may be imposed on a transmitting WTRU, where CRₗᵢₘᵢₜ is a function of CBR (constant bit rate) and the priority of the sidelink transmissions. In an example embodiment, the amount of resources occupied by a transmitting WTRU may not exceed CRₗᵢₘᵢₜ.

The CBR report also may be used by the gNB to determine the pool of resources allocated to sidelink communication (e.g., increase the pool of resources if the WTRUs involved in sidelink communication are reporting high CBRs, decrease the pool of resources if the CBRs reported are low, etc.).

In addition to peer WTRUs involved in sidelink operation configuring each other for measurement (either periodical or S1/S2 events), for in coverage operation (e.g., the remote WTRU is within the coverage of the gNB), the gNB may configure the remote WTRU with CBR measurements, which may be either periodical or event triggered. The following two measurement events may be configured for CBR measurement reporting. Event C1 (CBR of NR sidelink communication becomes better than absolute threshold) and Event C2 (CBR of NR sidelink communication becomes worse than absolute threshold).

In CHO in Uu, a WTRU may perform HO to a preconfigured target cell when some conditions associated with the source and target cell quality are met. This avoids having the WTRU send measurement reports to the network for the network to make the HO decision, since the measurement reports or the HO command itself could be degraded/lost, resulting in RLF prior to the execution of the HO.

Since there is a possibility of a direct/indirect to indirect CHO, more than one WTRU may be involved in the final switching (e.g., the remote WTRU and the target relay WTRU), which is different from a legacy CHO where only one WTRU is involved. Since there may be several target relay WTRUs that are being served by a given target cell, configuring the WTRU with different events for each possible target relay may surpass a WTRU's capability for the number of CHO configurations. Whether the final decision of the target relay is to be performed by the source gNB or target gNB also may impact on how CHO operates in the SL relay scenarios.

Various embodiments discussed herein address how to efficiently enable conditional path switching for a remote WTRU from a direct/indirect link to an indirect link. In one example embodiment, a remote WTRU may perform conditional path switching, wherein the remote WTRU connects to a target cell via one of the relay WTRUs under the target cell when the radio conditions between the remote WTRU and one of the relay WTRUs fulfill a path switching triggering condition (e.g., above absolute threshold, better than the serving link by a certain threshold, etc.). Upon the completion of the connection, the remote WTRU may send an RRC reconfiguration complete message that includes the remote WTRU's identity.

In another example embodiment, target relay WTRU selection may be made by a target gNB after initial conditional path switching by the remote WTRU. After performing a path switching via a certain relay WTRU, a remote WTRU keeps other conditional path switch configurations (e.g., for a certain configured time) and sends SL measurements of other candidate relay WTRUs to the target gNB (e.g., in the RRC reconfiguration complete message). If the remote WTRU receives an indication from the target gNB (e.g., MAC CE, RRC) with an identity of one of the candidate relays, it performs the path switching to the indicated relay WTRU.

In another example embodiment, a relay WTRU may be prepared for path switching of a remote WTRU. A relay WTRU may be configured/prepared to serve one or more remote WTRUs. Upon receiving an indication from the remote WTRU that the remote WTRU has performed path switching via the relay WTRU, the relay WTRU may apply the configurations that are associated with the remote WTRU (e.g., (re)configure/setup the SL between the remote WTRU and the relay WTRU such as the RLC channels, (re)configure the backhaul Uu, apply SRAP configuration for mapping the SL and Uu RLC channels, etc.).

In another example embodiment, redundancy may be utilized to handle failure cases such as a congested target relay WTRU or a bad backhaul to the targe gNB. A remote WTRU, upon performing path switching to a target relay WTRU, may send an indication to the network about the path switching via multiple candidate relay WTRUs (e.g., other relay WTRUs serving the same cell as the target relay WTRU), and the remote WTRU receiving from the network a confirmation about the path switching to the target relay WTRU or an indication to switch to one of the other candidate relay WTRUs.

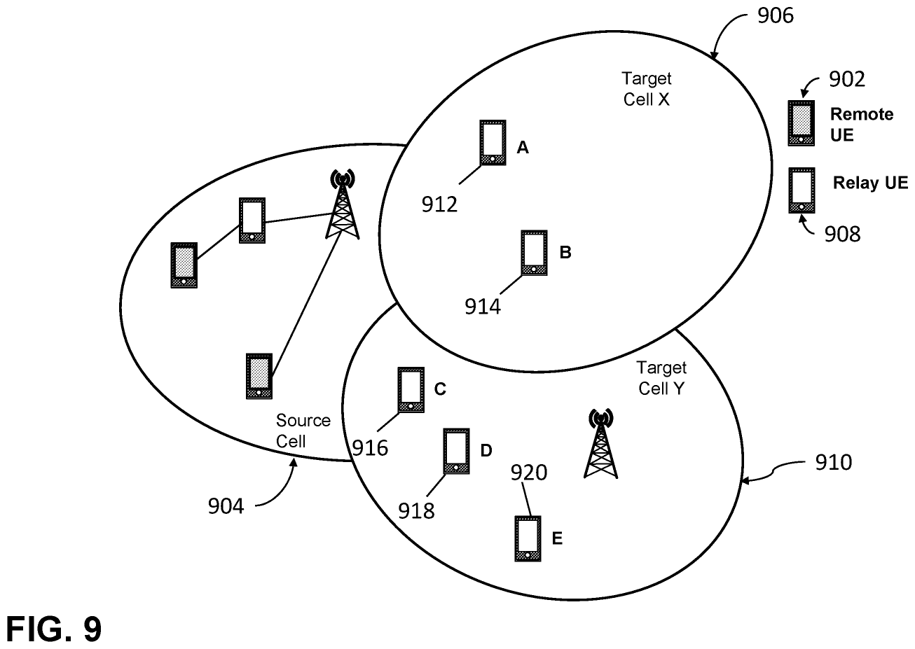

FIG. 9 depicts an example conditional handover scenario. FIG. 9 is referred to below to describe the different embodiments for CHO operations in the direct/indirect to indirect path switching. As depicted in FIG. 9, a remote WTRU 902 is being served in the source cell 904 (either directly or via a SL relay 908) and there are two candidate target cells (target cell 906—also depicted as target cell x, and target cell 910—also depicted as target cell y), where 2 relay WTRUs (relay WTRU 912—also depicted as relay WTRU B, relay WTRU 914—also depicted as relay WTRU B) are under target cell 906 and 3 relay WTRUs, relay WTRU 916—also depicted as relay WTRU C, relay WTRU 918—also depicted as relay WTRU D, relay WTRU 920—also depicted as relay WTRU E, are under target cell 910. There are several possible handovers or path switching that the WTRU 902 may perform. For example, any appropriate combination of the following handovers may be performed: [Case 1] WTRU HO directly to target cell 906; [Case 2] WTRU HO directly to target cell 910; [Case 3] WTRU HO via relay WTRU 912 of target cell 906; [Case 4] WTRU HO via relay WTRU 914 of target cell 906; [Case 5] WTRU HO via relay WTRU 916 of target cell 910; [Case 6] WTRU HO via relay WTRU 918 of target cell 910; and [Case 7] WTRU HO via relay WTRU 920 of target cell 910. There may be a combination of some of the cases as well for the sake of multipath (e.g., cases 1+3, where the WTRU ends up being connected both directly and via relay WTRU 912 to target cell 906.

As described herein, the terms PC5 and SL are used interchangeably. The terms reconfiguration and configuration are used interchangeably. The terms reconfiguration complete message, RRC reconfiguration complete message, RRC complete message, path switching complete message and complete message are used interchangeably. The terms path switch and path switching are used interchangeably. The terms candidate and target relays are used interchangeably. Although the focus is on L2 U2N relay case, the solutions are equally applicable to any appropriate layer (e.g., layer 3 (L3), network, or the like. Unless otherwise specified, a WTRU in the discussion below refers to a remote WTRU. Unless otherwise specified, the term source refers to a source gNB/network node/cell. Unless otherwise specified, the term target refers to a target gNB/network node/cell. The terms conditional handover (CHO), conditional mobility, and conditional path switching (CPS), are used interchangeably. In the descriptions below, the phrase “measurements of a certain relay,” unless otherwise specified, is meant to describe the SL measurements between the remote WTRU and the relay WTRU.

Conditional mobility is considered herein. However, some aspects are equally applicable to legacy mobility based on measurements (e.g., the new measurement events proposed here may be used to send measurement reports to the source gNB instead of triggering a conditional path switching).

In the descriptions below, the conditional path switching configuration at the remote WTRU may be any information element (IE) within an RRC Reconfiguration message that is relevant for the operation of the remote WTRU via a SL relay. This includes, but not limited to dedicated configuration for the PC5 link, including information such as the PC5 PHY/MAC configuration, RLC channels, bearers, measurements, DRX, etc., (e.g., indicated in the SL-ConfigDedicatedNR IE), and SRAP configurations, serving cell information, etc., (e.g., indicated in SL-L2RelayUEConfig IE), and identity of the target relay WTRU (e.g., included in the sl-PathSwitchConfig IE).

In an example process in which a remote WTRU (e.g., remote WTRU 902) is configured for conditional path switching, the remote WTRU may receive conditional path switch configuration information towards (associated with) a target cell (e.g., target cell 906, target cell 910). The conditional path switch information may be received via a relay WTRU. The conditional path switch configuration information may comprise a triggering condition, or conditions (e.g., at least one relay WTRU under the target cell fulfilling an absolute or relative threshold) and may comprise corresponding RRC reconfiguration (e.g., SL path switch reconfiguration information and other related configuration to the SL and remote WTRU operation). The triggering condition(s) and SL reconfiguration information may be associated with more than one (a plurality) candidate relay WTRUs (e.g., relay WTRU 908, relay WTRU 912, relay WTRU 914, relay WTRU 916, relay WTRU 918, relay WTRU 920). The remote WTRU (e.g., remote WTRU 902) may monitor the triggering condition(s) for one or more or the relay WTRUs under the target cell. Upon determining the triggering condition(s) are fulfilled (has been satisfied) by one of the relay WTRUs, the remote WTRU may apply the RRC reconfiguration information associated with the chosen target relay WTRU. The remote WTRU may send the RRCReconfiguration Complete message to a network node (e.g. gNB) via the chosen target relay WTRU, where the message may contain the identity of the remote WTRU. The remote WTRU may release the conditional path switch configurations associated with other relay WTRUs (e.g., the other relay WTRUs of the plurality of relay WTRUs).

Target relay WTRU selection may be accomplished by a target network node (e.g., gNB) after initial conditional path switching by the remote WTRU. In some scenarios, due to the lack of knowledge of the conditions of the backhaul Uu path from the candidate relay WTRUs to the target gNB, the path switching decision that is based on just SL conditions may not be sufficient. For example, the remote WTRU may end up performing path switching to a certain relay WTRU (e.g., based on the reception of a path switching configuration from the source gNB, based on the fulfillment of the triggering conditions of a conditional path switching configuration, etc.,) that has very good SL conditions but not the best backhaul Uu, as compared to other candidate relay WTRUs. Embodiments are described herein that enable a mechanism where the target gNB may change the chosen relay by the WTRU immediately after the path switching (e.g., after considering backhaul Uu conditions of the relay where the WTRU has changed its path to and other candidate relay WTRUs).

In one example embodiment, the remote WTRU may start a timer (with a configured value) after sending the path switching complete message. The WTRU may keep/maintain some or all the conditional path switching configurations until the timer expires (e.g., all the conditional path switching configuration associated with the relay WTRUs under the same target cells as the relay where the WTRU has switched its path to). When the timer expires, the configurations may be released, if not released earlier due to some of the solutions described below.

In another example embodiment, keeping/maintaining a conditional path switch configuration may entail performing measurements and monitoring the conditions associated with the path switch configuration. In another example embodiment, keeping/maintaining a conditional path switch configuration may mean just keeping the configuration stored (e.g., the WTRU will not monitor the triggering conditions for the path switching configuration). In another example embodiment, the remote WTRU may send to the network the measurements (e.g., SL/SD-RSRP) of the chosen target relay WTRU and/or the identities and measurements of other candidate relay WTRUs (e.g., in the reconfiguration complete message, a separate message immediately after or multiplexed with the reconfiguration complete message, etc.). In another example embodiment, the other indicated candidate relay WTRUs may be the relay WTRUs that are serving the same cell as the chosen target relay WTRU. In another example embodiment, the other indicated candidate relay WTRUs may be the relay WTRUs that are serving any cell that belongs to the same gNB as the gNB of the cell of the chosen target relay WTRU. In another example embodiment, the other indicated relay WTRUs could be relay WTRUs that are serving cells that belong to a gNB different from the gNB of the cell of the chosen target relay WTRU. In another example embodiment, only the candidate relay WTRUs that fulfill a certain SL radio condition are indicated by the remote WTRU (e.g., SL radio above a configured threshold). In another example embodiment, only the candidate relay WTRUs that fulfill a certain SL congestion/load condition are indicated by the remote WTRU (e.g., CBR/CR below a configured threshold). In another example embodiment, the remote WTRU, after completing the path switching and has sent the reconfiguration complete message to the target gNB, may receive an indication from the target gNB to switch the path to another relay WTRU (e.g., one of the other candidate relay WTRUs that the WTRU has indicated earlier). In another example embodiment, this indication may include the identity (e.g., L2 relay WTRU ID) of the relay WTRU to which the remote WTRU should switch the path to. In another example embodiment, this indication may be received in a MAC CE (control element). In another example embodiment, this indication may be received in an RRC reconfiguration message (e.g., possibly including additional/delta reconfiguration related to SL/relaying operations).

In another example embodiment, the indication may be received via the target relay WTRU via which the reconfiguration complete message was originally sent to the target gNB (e.g., the relay WTRU to which the WTRU has switched the path to). In another example embodiment, the indication may be received via a different target relay WTRU chosen by the target gNB. For example, a PC5 connection setup request or reconfiguration message may be received from the new target relay WTRU, with an implicit or explicit indication that the path is to be switched to this relay WTRU. In another example embodiment, the remote WTRU may apply the path switching to the indicated new target relay WTRU without checking any additional conditions (e.g., the triggering conditions associated with the indicated relay WTRU in the saved conditional path switch reconfiguration). In another example embodiment, the remote WTRU may apply the path switching to the indicated new target relay WTRU only if the triggering conditions associated with the indicated relay WTRU in the saved conditional path switch reconfiguration are fulfilled. In another example embodiment, the remote WTRU, after switching the path to the relay WTRU indicated in the received indication, may release some or all the saved, if any, conditional path switch configurations (even if a timer associated with keeping the configurations is still running).

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods, apparatuses, and articles of manufacture, within the scope of the disclosure, in addition to those enumerated herein, will be apparent to those skilled in the art from the foregoing descriptions. Such modifications and variations are intended to fall within the scope of the appended claims.

In addition, methods provided herein may be implemented in a computer program, software, or firmware incorporated in a computer-readable medium for execution by a computer or processor. Examples of computer-readable media include electronic signals (transmitted over wired or wireless connections) and computer-readable storage media (which do not include transitory signals). Examples of computer-readable storage media, which are differentiated from signals, include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

In an illustrative embodiment, any of the operations, processes, etc. described herein may be implemented as computer-readable instructions stored on a computer-readable storage medium. The computer-readable instructions may be executed by a processor of a mobile unit, a network element, and/or any other computing device.

What is claimed is:

1. A remote wireless transmit/receive unit (WTRU) comprising:
a transceiver; and
a processor configured to:
receive, via the transceiver, conditional path switching configuration information associated with a target cell, wherein the conditional path switching configuration information is received via a relay WTRU, and wherein the conditional path switching configuration information comprises a triggering condition and sidelink (SL) reconfiguration information associated with each of a plurality of candidate relay WTRUs;
determine that the triggering condition has been satisfied for a target relay WTRU of the plurality of candidate relay WTRUs associated with the target cell; and
upon the determination that the triggering condition has been satisfied:
apply the conditional path switching configuration information associated with the target relay WTRU;
send, via the transceiver, a message to a network node, wherein the message is sent via the target relay WTRU, and wherein the message comprises an identity of the remote WTRU; and
release the conditional path switching configuration information associated with each of the candidate relay WTRUs of the plurality of candidate relay WTRUs other than the target relay WTRU.

2. The remote WTRU of claim 1, wherein to release the conditional path switching configuration information associated with each of the candidate relay WTRUs of the plurality of candidate relay WTRUs other than the target relay WTRU comprising to release a respective PC5 link with each of the candidate relay WTRUs of the plurality of candidate relay WTRUs other than the target relay WTRU.

3. The remote WTRU of claim 1, wherein the triggering condition comprises a measurement threshold associated with one or more relay WTRUs associated with the target cell.

4. The remote WTRU of claim 1, wherein the triggering condition is based on a radio quality associated with the target cell.

5. The remote WTRU of claim 1, wherein the triggering condition is based on a radio quality associated with the target cell and a neighbor cell to trigger a measurement report.

6. The remote WTRU of claim 1, wherein the received conditional path switching configuration information comprises radio resource control (RRC) information.

7. The remote WTRU of claim 1, wherein the SL reconfiguration information comprises an SL path switch configuration.

8. The remote WTRU of claim 1, wherein the SL reconfiguration information comprises information associated with SL-related operations of the remote WTRU.

9. The remote WTRU of claim 1, wherein the message comprises an RRCReconfigurationComplete message.

10. A method performed by a remote wireless transmit/receive unit (WTRU), the method comprising:
receiving conditional path switching configuration information associated with a target cell, wherein the conditional path switching configuration information is received via a relay WTRU, and wherein the conditional path switching configuration information comprises a triggering condition and sidelink (SL) reconfiguration information associated with each of a plurality of candidate relay WTRUs;
determining that the triggering condition has been satisfied for a target relay WTRU of the plurality of candidate relay WTRUs associated with the target cell; and
upon the determining that the triggering condition has been satisfied:
applying the conditional path switching configuration information associated with the target relay WTRU;
sending a message via the target relay WTRU, and wherein the message comprises an identity of the remote WTRU; and
releasing the conditional path switching configuration information associated with each of the candidate relay WTRUs of the plurality of candidate relay WTRUs other than the target relay WTRU.

11. The method of claim 10, wherein releasing the conditional path switching configuration information associated with each of the candidate relay WTRUs of the plurality of candidate relay WTRUs other than the target relay WTRU comprising to releasing a respective PC5 link with each of the candidate relay WTRUs of the plurality of candidate relay WTRUs other than the target relay WTRU.

12. The method of claim 10, wherein the triggering condition comprises a measurement threshold associated with one or more relay WTRUs associated with the target cell.

13. The method of claim 10, wherein the triggering condition is based on a radio quality associated with the target cell.

14. The method of claim 10, wherein the triggering condition is based on a radio quality associated with the target cell and a neighbor cell to trigger a measurement report.

15. The method of claim 10, wherein the received conditional path switching configuration information comprises radio resource control (RRC) information.

16. The method of claim 10, wherein the SL reconfiguration information comprises an SL path switch configuration.

17. The method of claim 10, wherein the SL configuration information comprises information associated with SL-related operations of the remote WTRU.

18. The method of claim 10, wherein the message comprises an RRCReconfigurationComplete message.

19. At least one computer-readable storage medium having program instructions stored thereon that when executed by a processor, cause the processer to:
receive conditional path switching configuration information associated with a target cell, wherein the conditional path switching configuration information is received via a relay WTRU, and wherein the conditional path switching configuration information comprises a triggering condition and sidelink (SL) configuration information associated with each of a plurality of candidate relay WTRUs;
determine that the triggering condition has been satisfied for a target relay WTRU of the plurality of candidate relay WTRUs associated with the target cell; and
upon the determination that the triggering condition has been satisfied:
apply the conditional path switching configuration information associated with the target relay WTRU;
send a message via the target relay WTRU, and wherein the message comprises an identity of the remote WTRU; and
release the conditional path switching configuration information associated with each of the candidate relay WTRUs of the plurality of candidate relay WTRUs other than the target relay WTRU.

20. The at least one computer-readable storage medium of claim 17, wherein the triggering condition comprises a measurement threshold associated with one or more relay WTRUs associated with the target cell.
